(19) United States
(12) Patent Application Publication
(10) Pub. No.: US 2012/0313521 A1
(43) Pub. Date: Dec. 13, 2012

(54) Heat shield on a compact fluorescent lamp

(76) Inventor: Earl W. Roberts, Mystic, CT (US)

(21) Appl. No.: 13/134,475

(22) Filed: Jun. 9, 2011

(51) Int. Cl. H01J 61/52; H01J 61/56

(52) U.S. Cl. 315/56

(57) ABSTRACT

The inventive concept is directed to a heat shield on a Compact Fluorescent Lamp CFL. When a CFL is installed in an upside down position, that is, the screw-in section is up and the lighted section is down, the heat created by the lighted section rises and impacts on the ballast section right above it. The ballast section may malfunction and may fail altogether. The heat shield is of a conical configuration and the smaller diameter end is slipped over the threaded section but will stop just above the wider diameter of the ballast section. This way, the heat cannot reach the ballast section to greatly prolong the life span of the CFL. On an upper section of the heat shield there are provided spring retainers which will provide a snug fit of the heat shield on the top of the ballast. The heat shield may be adjusted into somewhat different directions to enhance the direction of the light emanating from under the heat shield. This light may be enhanced by providing a reflective surface on the inside of the heat shield.

### BACKGROUND OF THE INVENTION

The Achilles heel of all electronic products and components is “heat”. In most electronic products, where heat is a problem, fans or heat sinks are provided to keep the temperature of the affected parts within their acceptable temperature limits. The usage of compact fluorescent lamps, CFC's, has become very wide-spread lately, and the U.S. Government will impose requirements for even wider usage of CFL lamps as of Jan. 1, 2012. The CFL lamps generally perform well when installed in a base down configuration. However, many applications require that they CFL lamps be installed in a face-up configuration. Under theses conditions, the heat from the lamp rises and can overheat the electronic ballast that is present in the base of the lamp. Experience has shown that these lamps fail prematurely, far short of their advertised life span. Fires have been reported, caused by overheated CFL ballasts.

### BRIEF DESCRIPTION OF THE INVENTION

The inventive process provides a simple, easily-installed, inexpensive CFL heat shield that can be inserted over the base of a CFL lamp before installation of the lamp which will greatly extend the life span of the lamp. The shield will provide a degree of protection against ignition of the ballast that might occur without the heat shield. The CFL shield can also produce an additional benefit and that is the ability to direct or reflect the light in different directions as desired.

### BRIEF DESCRIPTION OF THE DRAWINGS

FIG. 1 illustrates the prior art CFL lamp;

FIG. 2 is a perspective view of the heat shield on a CFL lamp;

FIG. 3 is a perspective bottom view of the heat shield;

FIG. 4 is a perspective top view of the heat shield.

### DETAILED DESCRIPTION OF THE INVENTION

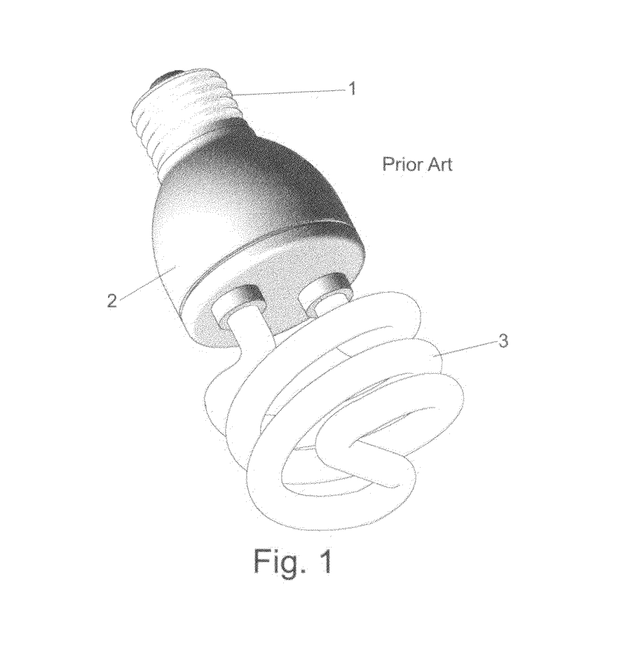

FIG. 1 shows the prior art CFL lamp in its well known construction. The threaded section 1 is used to screw the bulb into the appropriate socket. Below the thread section is the well known ballast from which the glass tube 3 extends. As explained above, when the lamp is installed in a downwardly extending direction, the lit glass tube, which is creating heat, may rise to the ballast 2 and may cause the ballast to malfunction.

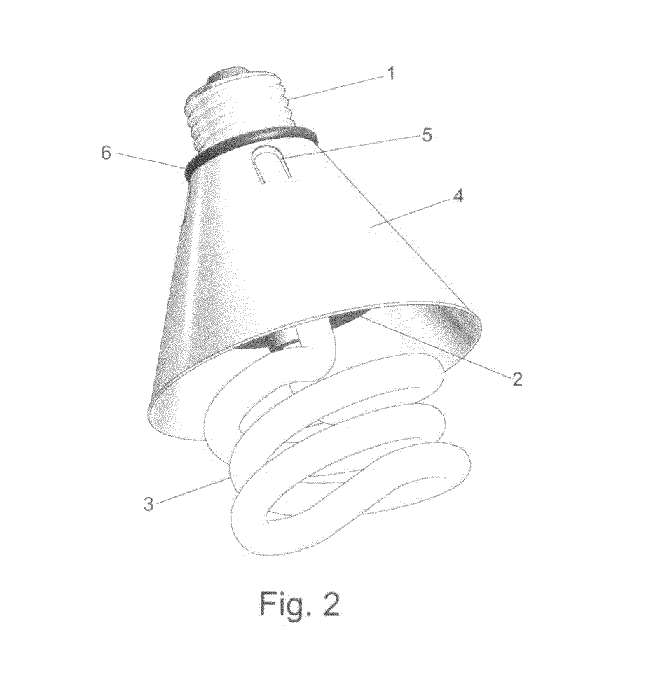

FIG. 2 is a perspective view of CFL light bulb 1 with the heat shield 4 installed over the ballast 2. The heat shield is of such a dimension that the smallest diameter will just pass over the threaded part 1 of the CFL lamp and remain there after being trapped over the next larger diameter of the ballast 2. The heat shield 4 is of a conical configuration with the wider or larger diameter spreading out from the glass part 3 of the lamp. The heat shield should be made of metal such zinc, stainless steel, copper, brass or aluminum. The smaller diameter of the heat shield 4 has a grommet 6 installed at this end. The grommet is electrically insulating the metal to thereby shield the heat shield 4 from any accidental contact with the lamp or the lamp holder screw shell. Also shown in FIG. 2 are retainer springs 5 which enhance a snug fit of the heat shield in its predetermined position.

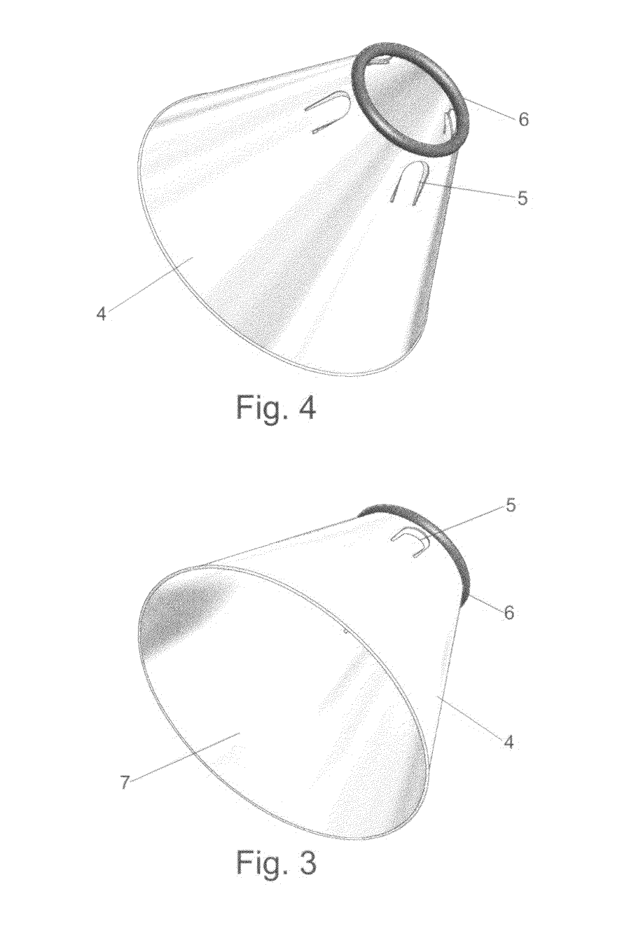

FIG. 3 illustrates a perspective bottom view of the heat shield 4. As can clearly be seen from this illustration, the heat shield is of a conical configuration. Because of this configuration, the heat shield can be moved into somewhat different directions to thereby direct the light into different direction also. The inside surface may have added thereto a sheen as shown at 7 which may be created by a high gloss of the metal or any light reflecting paint. The heat shield has spring members 5 that will assist the shield 4 to stabilize the same once moved into somewhat different directions The heat shield at its smallest diameter has an electrical insulating grommet 6 thereat to act as a heat shield from any heat emanating from the ballast and its surroundings. Also shown in FIG. 2 are spring members 5 that may be punched from the material of the heat shield or attached separately. The purpose of the spring members 5 is to adjust the heat shield to varying sizes, profiles, or different contours of the CFL lamp.

FIG. 4 is perspective view seen from the top. The same reference characters have been used as was in previous Figs. Nor further explanation is deemed to be necessary.

What I claim is:

1. An improvement in a Compact Fluorescent Lamp, CFL, having a screw-in section, a ballast section and a lighted section when installed in a downwardly pointing position, the improvement comprising: means for preventing any heat rising from said lighted section to reach said ballast.

2. The improvement in said CFL, wherein said means for preventing is a heat shield placed over said lighted section and below said ballast.

3. The improvement in said CFL of claim 2, wherein said heat shield is of a conical configuration with the smaller diameter of said conical configuration being placed just below the location of said ballast.

4. The improvement in said CFL of claim 2, wherein retainer springs are provided to obtain a snug fit of said heat shield on said ballast.

5. The improvement in said CFL of claim 2 including a sheen generating surface in an inside surface of said heat shield.

6. The improvement in said CFL of claim 1 including a grommet placed at an end of said heat shield closest to said ballast section at an upper end thereof.

7. The improvement in said CFL of claim 2, wherein said heat shield is made of metal selected form the group of metals consisting of zinc, stainless steel. Copper, brass or aluminum.
